(19) United States
(12) Patent Application Publication
(10) Pub. No.: US 2024/0175141 A1
(43) Pub. Date: May 30, 2024

(54) BIOBASED AND BIODEGRADABLE CORROSION INHIBITION COMPOSITION

(71) Applicant: ZestBio, Inc., Berkeley, CA (US)

(72) Inventors: Luke Latimer, Hayward, CA (US); Ryan Protzko, Mariottsville, MD (US); Nicole Nelson, Albany, CA (US)

(21) Appl. No.: 18/487,974

(22) Filed: Oct. 16, 2023

Related U.S. Application Data
(60) Provisional application No. 63/379,536, filed on Oct. 14, 2022.

(51) Int. Cl. C23F 11/18

(52) U.S. Cl. CPC C23F 11/182

(57) ABSTRACT

A composition to mitigate metal corrosion that could be used within a fluidic system. The composition can include mixtures containing an organic compound with carboxylic functional group, which may include a hydroxydicarboxylic acid or salt thereof, an amino acid, or an amino acid polymer in combination with an aromatic compound and/or a buffer.

### CROSS-REFERENCE TO RELATED APPLICATIONS

This Application claims the benefit of U.S. Provisional Application No. 63/379,536, filed on 14 Oct. 2022, titled “A BIOBASED AND BIODEGRADABLE CORROSION INHIBITION COMPOSITION”, which is incorporated in its entirety by this reference.

### TECHNICAL FIELD

This invention relates generally to the field of corrosion inhibitors, and more specifically to a new and useful composition and method for the production and application of a biobased and biodegradable corrosion inhibition composition.

### BACKGROUND

Metal components are an integral part of the general infrastructure of our society. For metal components exposed to the elements, or situated in water, corrosion is a serious issue that must be dealt with regularly. Corrosion inhibitors are used in most environments where metal is consistently in contact with water and where the makeup of the water can be, at least somewhat, controlled (e.g. it's feasible to add chemicals to the water). To date, there have been many chemical treatments that have been developed to prevent and/or reduce corrosion.

A major drawback of the majority of these products is their cost and environmental impact. Costs can be from both direct use and the cost of disposal. Most corrosion inhibiting chemicals (e.g., phosphates, nitrites, molybdates) have a significant environmental impact. For example, historically, one of the best corrosion inhibitors used was chromates because they are low cost and effective at preventing corrosion even at low concentrations. Chromates are now banned almost everywhere due to their toxicity and carcinogenicity. For closed loop systems (those systems that have low rates of water loss/replacement each year), high concentrations of corrosion inhibitors are frequently used—mainly nitrites, molybdate, or phosphates. Nitrites are susceptible to microbial contamination, which can increase corrosion, increase costs as additional chemical needs to be added and fouling can block flow through restricted areas. Molybdate is nearly 10-fold more expensive than nitrites and it's drain disposal is banned in select municipalities. Phosphates are also susceptible to microbial contamination and they are also restricted for disposal in select municipalities due to their promotion of eutrophication of waterways.

For cooling tower systems, water is evaporated to eject heat from the system. This concentrates all ions and chemicals in the water resulting in increased corrosion and risk of scale formation including, but not limited to, chloride ions, calcium carbonate and calcium phosphate scales. To mitigate these problems, water is constantly removed from the system and disposed to keep the concentrations of ions and chemicals stable. With the large turnover in water, low concentrations of corrosion inhibitors are necessary. One strategy to mitigate corrosion is to use more resistant materials, particularly galvanized steel. Galvanized steel has a protective zinc coating applied to steel or iron to decrease rates of corrosion. The zinc coating dramatically reduces corrosion rates while it remains intact and while the operating conditions are correct. However, there are limited options for chemicals to supplement protection of the galvanized steel from corrosion if the operating conditions stray and the water may require additional pre-treatment before use to fall within the allowable conditions.

Thus, there is a need in the field of corrosion prevention for a biobased and biodegradable corrosion inhibition composition, as provided by this invention. This invention provides such new and useful compositions, systems, and methods.

### BRIEF DESCRIPTION OF THE FIGURES

FIG. 1 is a table of example compositions for corrosion inhibition.

FIG. 2 is a table of example compositions for corrosion inhibition at pH 7.

FIG. 3 is a plot of corrosion rates in mils per year for carbon steel electrodes as measured by linear polarization resistance for electrodes submerged in tap water supplemented with the indicated chemicals: tartaric acid (500 ppm); borate (167 ppm); imidazole (333 ppm).

FIG. 4 is a plot of corrosion inhibition efficiency for carbon steel coupons treated with corrosion inhibition compositions with varying ratios of tartaric acid and imidazole.

FIG. 5 is a table showing the corrosion inhibition efficiency for compositions containing tartaric acid, imidazole, and sodium benzoate.

FIG. 6 is a table showing the corrosion inhibition efficiency for compositions containing propylene glycol in water.

FIG. 7 is a table of example corrosion inhibition compositions (ppm dissolved in tap water with pH adjusted with NaOH) prepared and applied to aluminum coupons in solution for 14 days.

FIG. 8 is a table of example compositions for corrosion inhibition that include polyaspartic acid.

FIG. 9 is flowchart of an example method.

FIG. 10 is a plot of corrosion inhibition efficiency for galvanized steel coupons treated with the method of applying corrosion inhibition compositions with varying ratios of galactaric acid and sodium borate decahydrate.

FIG. 11 is a plot of corrosion inhibition efficiency for galvanized steel coupons treated with the method of applying a galvanized steel corrosion inhibition composition at varying concentrations in water.

FIG. 12 is a table of example corrosion inhibition compositions (ppm dissolved in water at pH 9.5) prepared and applied to galvanized steel.

### DESCRIPTION OF THE EMBODIMENTS

The following description of the embodiments of the invention is not intended to limit the invention to these embodiments but rather to enable a person skilled in the art to make and use this invention.

### 1. Overview

As described herein, compositions, systems, and methods for production and application of a corrosion inhibition function to leverage synergistic properties discovered between organic compounds with a carboxylic functional group (e.g., an aldaric acid) and various materials such as aromatic compounds and/or borate salts.

The compositions, systems, and methods, in one variation, may use a corrosion inhibitor combining one or more of a hydroxy-carboxylic acid and one or more of an aromatic compound. The corrosion inhibitor may be applied to a metal surface or used within systems as a corrosion inhibitor. The composition may have applications to open and/or closed fluid systems that could benefit from corrosion inhibition for steel, aluminum, copper, brass and other metals. The system and method provide an implementation specific corrosion inhibitor that is biodegradable, that may, or may not, be used with other metal treatments (e.g., galvanized steel).

The compositions, systems, and methods, in another variation, may use a corrosion inhibitor combining one or more of a hydroxy-carboxylic acid and one or more borate compound. The composition may additionally include water soluble metal ions (zinc, tin, nickel, magnesium). This composition variation may have applications to corrosion inhibition for galvanized steel.

The compositions, systems and methods may be usable for the treatment of any type of metal, particularly in places where the metal may be susceptible to corrosion. In particular, the compositions described herein may have particular benefits corrosion inhibition in steel, aluminum, and galvanized steel.

The compositions, systems and methods may be used within fluid systems (e.g., water systems) which can include open and closed water systems. Examples of such water systems may include but not limited to: HVAC systems, other moisture inducing closed loops; boilers; water pipes (e.g., within buildings); cooling towers (e.g., power plants); oil and gas drilling components/systems; geothermal systems; metal coatings (e.g. paints); automotive systems like in cars or boats; salt water systems; and/or other systems.

The compositions, systems and methods may be used for the treatment of metal surfaces for the purpose of passivation. Examples of passivation include metalworking fluids, pretreatment of cleaned metal surfaces, spray application to prevent flash corrosion, treatment of fluid systems before shutdown, or treatment of metal surfaces prior to exposure to corrosive environments including salt water, salt water aerosol/spray, or high moisture air.

The system and method may provide a number of potential benefits. The system and method are not limited to always providing such benefits and are presented only as exemplary representations for how the system and method may be put to use. The list of benefits is not intended to be exhaustive and other benefits may additionally or alternatively exist.

As one potential benefit, the compositions, systems and methods described herein may provide a corrosion inhibition composition that is made of biodegradable components. Many traditional corrosion inhibitors are banned (e.g., chromates because of carcinogenicity) or have drain disposal bans (e.g., molybdate). The corrosion inhibitor compositions described herein, however, uses compounds that are biodegradable and would not be subject to such bans, restrictions, and/or other complications due to human toxicity or toxicity to the environment. In some variations, the compositions, systems and methods may use a composition that includes polyaspartate (e.g., an amino acid polymer). This provides the potential benefit of an easily and cheaply accessible component that is completely biofriendly.

As another potential benefit, the compositions, systems, and methods described herein may be microbially resistant. Some traditional corrosion inhibitor options, such as the use of nitrites or phosphates, can be susceptible to microbial contamination, which can increase corrosion and add further complications. The composition can avoid these complications.

As a related potential benefit, the compositions, systems, and methods, use a composition that does not react with calcium and avoids scale formation (calcium carbonate or calcium phosphate). This may allow the compositions, systems, and methods to avoid negative impacts to heat transfer (e.g., slowing heat transfer) that can result from such scale formation. Consequently, the corrosion inhibitors and/or fluids may not need to be cycled as frequently and lower volumes of the corrosion inhibitors may be used.

As another potential benefit, the compositions, systems, and methods may be more cost effective. The components comprising the corrosion inhibitor composition can be comparably less expensive than other traditional options such as molybdate. This lower cost benefit may additionally expand the types of applications where the composition can be used, where previously use of a corrosion inhibitor may have been cost prohibitive.

As another potential benefit, the compositions, systems, and methods may use a corrosion inhibition composition that may be used in a wide range of conditions including temperature and pH ranges. For example, the compositions, systems and methods may provide corrosion inhibition at neutral pHs; pH 6-8, and potentially at more extreme pHs: 1-14.

As another potential benefit, the compositions, systems, and methods may use a corrosion inhibition composition that passivates or coats the metal surface. For example, the compositions, systems and methods may provide protection against flash corrosion upon exposure to air, protection against corrosion after removal of the treatment fluid, or protection against corrosion when diluted to lower concentrations after initial treatment.

As a related side benefit, the compositions, systems, and methods may be used as corrosion inhibitors alongside aluminum, and copper because of the wider range of compatible conditions. For example, the corrosion inhibitor may be used at a pH lower than 8.5 which may enable it to be used within fluid systems with aluminum, where aluminum corrosion is naturally reduced at pH lower than 8.5. As another potential benefit, the corrosion inhibitor composition may be used to protect aluminum at a pH greater than 8.5, where aluminum corrosion is greater without a corrosion inhibitor.

### 2. Compositions and Systems of Application

The compositions and systems of application preferably leverages synergistic interactions involving an organic compound with a carboxylic functional group. The system functions as a treatment that reduces and/or prevents corrosion once the composition is applied to the metal object. The system may be implementation specific, such that different metal types (e.g., carbon steel, galvanized steel, steel alloys, stainless steel, copper, copper alloys, brass, aluminum, zinc alloys, etc.) and working conditions (e.g., pH, temperature, dissolved solutes), may benefit from additional components and different concentrations of system components.

The system may be applicable to any metal type, wherein based on the metal type, additional components may be included or removed as necessary. Examples of applicable steel types include: carbon steels, alloy steels (e.g., steel alloys containing copper, chromium, aluminum, manganese, silicon, nickel, titanium), stainless steels (e.g., austenitic, ferritic, martensitic), and tool steels (e.g., containing tungsten, molybdenum, cobalt and vanadium in varying quantities). Examples of applicable copper types include: copper, copper alloys (e.g. copper alloys containing zinc, tin, aluminum, silicon, nickel, manganese, iron, titanium). Examples of applicable aluminum types include: aluminum, aluminum alloys (e.g. aluminum alloys containing zinc, tin, silicon, nickel, manganese, iron, copper, titanium, magnesium, bismuth, lead, silver, zirconium, lithium, chromium). Depending on the implementation, the metal object may, or may not, be included as a system component. Depending on the application method and type of metal, the system may further include additional components to improve application of the composition to a metal object.

Additionally or alternatively, the system may be incorporated as part of, or in addition to, a metal treatment (e.g., steel corrosion treatment). Examples of metal treatments that may incorporate the system include: zinc phosphate priming, chemical/powder coating, paint, priming, sealant application, hot dipping/galvanization, and zinc spray metallizing. As part of these metal treatments, the system may further include the treatment compounds (e.g., zinc phosphate, zinc, etc.).

The compositions described herein are generally presented as proportional weight percentages (wt %), representative typically of weight percentages when combined in solid form. The composition when in use will most typically be in dilution (e.g., diluted in water or glycol for example). The ratios of the components will remain the same when diluted. The composition may be prepared as a dry solid composition, a concentrate (high-concentration intended for dilution when used), or in a diluted “in-use” form. The diluted forms may have differing concentration levels (often presented as ppm) discussed herein.

In a first group of variations, the organic compound with a carboxylic functional group involves the combination of the organic compound with carboxylic functional group with an aromatic compound. In a second group of variations, the organic compound with carboxylic functional group involves the combination of the organic compound with carboxylic functional group with a borate salt and its combinations.

In a first variation, a corrosion inhibitor composition functions through the synergistic interactions of an organic compound with a carboxylic functional group and an aromatic compound. In particular, the composition can include 20-85% of an organic compound with a carboxylic functional group; and 15-80% of an aromatic compound. In some variations, the composition more particularly includes 15-60% of a nitrogen containing aromatic heterocycle.

The organic compound with a carboxylic functional group may be a hydroxycarboxylic acid with two or three carboxylic functional groups and at least one hydroxyl functional group. The aromatic compound may be a heterocyclic aromatic compound. Furthermore, the composition may include multiple types of an organic compound/hydroxycarboxylic acids and/or multiple types of aromatic compounds. Accordingly, the composition can include 20-85% of at least one hydroxycarboxylic acid with two or three carboxylic functional groups and at least one hydroxyl functional group (e.g., one or more types of a hydroxycarboxylic acid); and 15-80% of at least one aromatic compound (e.g., one or more types of aromatic compounds).

This composition may have particular applications in steel corrosion inhibition, and may be used in various fluid systems (open and closed systems). Such a combination of an organic compound with a carboxylic functional group with an aromatic has been discovered to show synergistic corrosion inhibition greater than the expected results from the individual compounds as is discussed herein. Additionally, the composition may consist of biodegradable components that are not restricted for use. The composition can also be microbially-resistant and be low in component cost. The composition may additionally provide stable corrosion inhibition across temperature and pH ranges while using biodegradable components and without use of environmentally restricted chemicals. The compositions may additionally inhibit corrosion at neutral pHs such as pH range of 6-8, but may also be suitable for ranges 6-14. The compositions may additionally passivate the metal surface providing corrosion inhibition for the metal surface after removal of the composition. The composition may additionally inhibit corrosion at temperatures ranging from 0° C. to 100° C., but may also be suitable for ranges from −40° C. to 250° C.

The carboxylic functional group can be or include a hydroxy-carboxylic acid, an amino acid, and/or an amino acid polymer. The aromatic compound in some variations can be a 5-membered aromatic heterocycle or a 6-membered aromatic.

Accordingly in one such variation, the organic compound is a hydroxy-carboxylic acid and more specifically an aldaric acid. The aldaric acid may be selected from a group consisting of tartaric acid, galactaric acid, glucaric acid, arabinaric acid, malic acid, and xylaric acid.

In some variations, an amino acid or an amino acid polymer is used in combination with the aldaric acid, wherein the organic compound further comprises an amino acid and/or an amino acid polymer in addition to the aldaric acid. Accordingly, the composition may include 20-85% of organic compounds with a carboxylic functional group comprising at least an aldaric acid and an amino acid or an amino acid polymer; and 15-80% of an aromatic heterocycle.

In some variations, an amino acid or an amino acid polymer may be used in place of an aldaric acid, wherein the organic compound with a carboxylic functional group is an amino acid or an amino acid polymer. Accordingly, in one such variation, the composition may include 20-85% of an amino acid; and 15-80% of an aromatic heterocycle. In another variation, the composition may include 20-85% of an amino acid polymer; and 15-80% of an aromatic heterocycle. The amino acids or amino acid polymers used as the organic compound as a mixture of organic compounds can include, for example, aspartic acid, glutamic acid or their polymers—polyaspartate (e.g., polyaspartic acid) or polyglutamate (e.g., polyglutamic acid).

The variations combining an aldaric, amino acid, and/or an amino acid polymer with an aromatic, may additionally include a buffer such as a borate compound. Accordingly, the composition can include 20-85% of an organic compound with a carboxylic functional group (e.g., one or more of aldaric, amino acid, and/or an amino acid polymer); 15-80% of an aromatic heterocycle; and 0.1% to 5o% of a borate compound.

Various implementations of the composition may be used. As one general example of one such composition, in addition to the other example variations described herein, the composition may include the combination of tartaric acid and imidazole. More particularly, the exemplary composition may include 45-65% tartaric acid; and 25-45% imidazole. In one such exemplary variation, the composition may include 50% tartaric acid, 17% borate, and 33% imidazole. In another exemplary variation, the composition may include 60% tartaric acid, 8% borate, and 32% imidazole. In another exemplary variation, the composition may include 60% tartaric acid and 40% imidazole. Variations of these exemplary formulations, such as ones with variations in wt % of plus or minus 5%, for example, may retain synergistic corrosion inhibition properties. As discussed, alternative organic compounds and/or aromatic compounds may be used. For example, pyridine may be used as the aromatic compound in a composition that includes 60% tartaric acid and 40% pyridine.

The composition variations for corrosion inhibition may be dissolved in solution to 10-10,000 ppm. The composition variations may be used in water solution with operating pH of 6-12 and temperatures between −50° C. to 200° C. In other implementations the composition may be used in water solution with operating pH of 7-11 and temperatures between 0° C. to 120° C.

As another general example of a composition, the composition may include the combination of polyaspartic acid and imidazole. One such example composition may include 45-55% polyaspartic acid, 28-38% imidazole, and 12-22% borate salt. For example, one such composition may include 50% polyaspartic acid (PASP), 17% borate, 33% imidazole.

As discussed, one group of variations of the composition can involve a corrosion inhibitor composition that leverages the synergistic combination of an organic compound with carboxylic functional group and a borate compound and its combinations. This combination may include functionality to aid in mitigating corrosion with galvanized steel. Such a composition for corrosion inhibition in galvanized steel may include 20-80% of an organic compound with a carboxylic functional group or salt thereof; and 20-80% of borate compound. Such a composition has been discovered to be efficacious for zinc (galvanized steel) corrosion inhibition.

As in the other composition variation, the organic compound can be a hydroxy-carboxylic acid and more specifically an aldaric acid. The aldaric acid may be selected from a group consisting of tartaric acid, galactaric acid, glucaric acid, malic acid, arabinaric acid, and xylaric acid.

The borate compound may be selected from a group consisting of anhydrous Borax, sodium tetraborate decahydrate, sodium borate decahydrate, sodium borate pentahydrate, potassium borate, potassium tetraborate and its hydrates, potassium pentaborate, zinc borate, boric acid, boric oxide, or sodium metaborate.

The composition for corrosion prevention in galvanized steel may additionally include a metal treatment additive, wherein the composition comprises 0.1-10% metal treatment additive. The metal treatment additive may be selected from the group consisting of zinc, tin (II), nickel, magnesium or their salts thereof.

The composition variation for galvanized steel corrosion inhibition may be dissolved in solution to 10-5000 ppm. The composition may be used in water solution with operating pH of 7-12.

Various implementations of the composition may be used. As one general example of one such composition, in addition to the other example variations described herein, the composition may include the combination of galactaric acid and borate compound. More particularly, the exemplary composition may include 40-60% of galactaric acid and 40-60% of borate compound. The composition may be dissolved in solution to 100-1000 ppm in some implementations.

As a corrosion inhibitor, the system may come in different states/forms. For example, the system may come in a solid (e.g., powder), liquid (e.g., dissolved in water or solvent), and/or spray (e.g., aerosolized) form. The liquid form may further be prepared as a concentrate, which may function as a convenient form for distribution and storage before use. The liquid form may additionally be dissolved in a solvent during use. Dependent on these variations, the system may include different variations of the included components. For example, either the hydroxy-carboxylic acid or aromatic compound may be in a powdered form or in a liquid form. As used herein, reference to any compound may equally refer to a liquid or solid form of that compound. In liquid form, the compound may be dissolved in a solution at a range of concentrations between 1-1,500,000 ppm. When the composition is prepared as a concentrate intended for dilution in a solvent, the composition may have arbitrarily high ppm, even exceeding 1,500,00 ppm. That is, any reference to a solution, acid, or base, may equally refer to a conjugate base, conjugate acid, and/or a salt variation of the compound.

The concentration of the composition may depend on the form. When dissolved in a solvent for some corrosion inhibition applications the final working concentration may vary between 1-20,000 ppm. In some applications a final working concentration of the composition within a solvent could be 100-10,000 ppm. One typical targeted threshold for concentration during use could be greater than 200 ppm. For example, standard loading for a closed loop water system may be around 1000 ppm (1 g/L) or 0.1 wt %/v. Higher concentrations may be used, but may depend on system objectives and and/or cost targets. Similarly, some systems may only require lower concentrations such as 100-1000 ppm. In general a range 50-2000 ppm can maintain a desirable level efficacy while balancing a desire to use as little material as possible.

As a concentrate, the composition may be in concentrations exceeding the working concentration (e.g., up to 500 times greater than final concentration). A concentrate form of the composition may have a composition dissolved at 10,000-1,500,000 ppm or more. A concentrate 200,000-500,000 may be one typical exemplary concentration of a concentrate. As an example, the composition may be dissolved as a concentrate at 300,000 ppm (300 g/L or 30 wt %) or at 1,200,000 ppm. When used, the concentrate can dissolve to a concentration within or close to the working concentration. For example, in one variation, the composition may be dissolved at 5 ppm or 1000 ppm within a treated water system.

In one example, a concentrate may include the composition as a 25o g/L or 25% wt mix of tartaric acid, imidazole, and borate. The concentrate may be used in different doses to reach a targeted concentration within a water system. Higher doses may be used to reach a critical protection (e.g., up to 10 g/L or 1% wt). If there are lower targets (e.g., to reduce cost), lower doses may be used to reach a concentration of 100 ppm or 0.01 wt %/v.

Depending on the variation, the composition may be dissolved in any desired solvent and/or mixture of multiple solvents (e.g., water and/or glycol). Examples of solvents can include: water, methanol, ethanol, acetone, butanol, isopropanol, hexane, toluene, ethylbenzene, xylene, methyl ethyl ketone (MEK), methyl isobutyl ketone (MIBK), methyl amyl ketone (MAK), isophorone, diacetone alcohol, diisobutyl ketone, methyl acetate, ethyl acetate, butyl acetate, isopropyl acetate, isobutyl acetate, parachlorobenzotrifluoride (PCPTF), propylene carbonate, dimethyl carbonate, glycol ether esters, and glycol ethers including propylene glycol and ethylene glycol. The composition may be dissolved in a solution between 1-1,500,000 ppm.

The composition may include at least one hydroxy-carboxylic acid (or dependent on the composition state, a salt of the hydroxy-carboxylic acid). The at least one hydroxy-carboxylic acid and/or salt may comprise 20-85% of the composition. Each hydroxy-carboxylic acid and/or salt thereof is an organic compound comprising at least two carboxyl functional group and at least one hydroxyl groups. In some variations, the hydroxy-carboxylic acid may have two carboxylic acids. In some variations, the hydroxy-carboxylic acid may have three carboxylic acids. In some variations, the hydroxy-carboxylic acid may have four carboxylic acids. In some variations, the hydroxy-carboxylic acid may be an aldaric acid or salt thereof. Examples of hydroxy-carboxylic acids can include dicarboxylic acids such as galactaric acid, glucaric acid, xylaric acid, arabinaric acid, malic acid, and tartaric acid and tricarboxylic acids such as hydroxycitric acid. The hydroxy-carboxylic acids may exist in various stereoisomeric forms, including enantiomers and diastereomers. The hydroxy-carboxylic acids may exist as conjugate bases in various salt forms with one or more counterions. Examples of salt counterions include lithium, sodium, potassium, rubidium, cesium, magnesium, calcium, strontium, barium, manganese, iron, cobalt, nickel, copper, zinc, aluminum, gallium, molybdenum, silver, platinum, tin, ammonium, ammonium organic compounds. The hydroxy-carboxylic acids may exist in various lactone forms. In some variations the hydroxy-carboxylic acid may be galactaro-1,5-lactone, galactaro-1,4-lactone, or galactaro-6,3-dilactone. In some variations, the hydroxy-carboxylic acid may be a glucose oxidation product, a gluconic acid oxidation product, a gluconate, or a combination thereof. In some variations, the organic compound maybe or include a monocarboxylic acid. In some variations, a monocarboxylic acid may alternatively be used with a subset of aromatics such as 5-membered ring aromatics. Additionally, these acids may be included as salts. Specific example hydroxy-carboxylic acids are described herein, but as could be appreciated by one knowledgeable in the art, other hydroxy-carboxylic acids and their salts may alternatively be used.

In some variations, the hydroxy-carboxylic acid may be supplemented or replaced by an amino acid and/or an amino acid polymer. Accordingly, some composition variations may include an aldaric acid, an amino acid or an amino acid polymer, and an aromatic. Alternatively, the amino acid or amino acid polymer may be used in place of the aldaric acid, wherein the composition includes at least one of an amino acid or amino acid polymer in combination with an aromatic. The concentrations/percentages of an amino acid or an amino acid polymer will be in comparable ranges as the aldaric acid (e.g., 20-85%). An amino acid polymer is a chemical polymer composed of amino acids as monomeric units, where amino acids are chemicals containing at least one amino group and one carboxylic acid or salt thereof.

Examples of amino acids may include, but not limited to, aspartic acid and glutamic acid. Examples of amino acid polymers may include, but not limited to polyaspartate (e.g., polyaspartic acid or PASP) or polyglutamate (e.g., polyglutamic acid).

The organic compound with carboxylic functional group may in some variations be used in combination with at least one aromatic compound. More specifically, the composition may include the organic compound with carboxylic functional group in combination with a nitrogen containing aromatic heterocycle.

The at least one aromatic compound may comprise approximately 15% to 80% of the composition. The aromatic heterocycle may be a 5-membered aromatic compound or a 6-membered aromatic compound.

In some variations, the aromatic compound may be an aromatic compound represented by formula I:

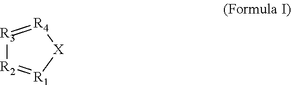

or the salts, or tautomers thereof. In Formula I, X may be selected from NR_{A}, S, or O; R₁-R₄, may each independently be selected from CR_{B}, N; R_{A} may be selected from H, C₁-C₂₀-alkyl, C₁-C₂₀-hydroxyalkyl, C₁-C₂₀-alkyl ether, C₁-C₂₀-aminoalkyl, C₁-C₂₀-alkyl carboxylic acid, C₁-C₂₀-alkyl carboxamide, C₁-C₂₀-alkenyl which may contain 1, 2, 3, 4, or 5 double bonds, alkyls partially substituted with carbocycles or heterocycles, and alkyls fully substituted with carbocycles or heterocycles; and R_{B} is independently selected from H, F, Cl, Br, OH, NO₂, CN, CHO, C₁-C₂₀-alkyl, C₁-C₂₀-hydroxyalkyl, C₁-C₂₀-alkyl ether, C₁-C₂₀-aminoalkyl, C₁-C₂₀-aminoalkyl carboxylic acid, C₁-C₂₀-alkyl carboxylic acid, C₁-C₂₀-alkyl carboxamide, C₁-C₂₀-alkenyl which contains 1, 2, 3, 4, or 5 double bonds, alkyls partially substituted with carbocycles or heterocycles (e.g., phenyltetrazole), alkyls fully substituted with carbocycles or heterocycles, and an option wherein at least one pair of R1, R2, R3, and R4 are taken together, with intervening atoms, to form a carbocycle, a heterocycle, a substituted carbocycle, or a substituted heterocycle. The options of possible pairings of R₁, R₂, R₃, and R₄ may be or include options where: R1 and R2 are taken together, with intervening atoms, to form a carbocycle, heterocycle, substituted carbocycle, or substituted heterocycle; R2 and R3 are taken together, with intervening atoms, to form a carbocycle or substituted carbocycle; R₁ and R₂ and R3 and R4 are taken together, with intervening atoms, to form a carbocycle or substituted carbocycle. Substitutions off the carbocycle or heterocycle formed by pairing of R1, R2, R3, and R4 may include H, F, Cl, Br, OH, NH2, NO2, CN, CHO, C1-C20-alkyl, C1-C20-hydroxyalkyl, C1-C20-alkyl ether, C1-C20-aminoalkyl, C1-C20-alkyl carboxylic acid, C1-C20-aminoalkyl carboxylic acid, C1-C20-alkyl carboxamide, C1-C20-alkenyl which contains 1, 2, 3, 4, or 5 double bonds. The formula components of X, R₁-R₄, and R_{A} may be selected from sets consisting of the options described above or any subset of options described herein.

Examples of compounds of type formula I may include: pyrrole, imidazole, triazole, pyrazole, thiophene, thiazole, benzothiazole, benzothiophene, oxazole, isoxazole, benzoxazole, benzisoxazole, indazole, indole, benzimidazole, N-methylpyrrole, 1-(Dimethylamino)pyrrole, pyrrole-2-carboxylic acid, pyrrole-1-propionic acid, pyrrole-2-carboxamide, (1-methyl-pyrrol-2-yl)methylamine, 1-aminopyroole, 2-methyl-pyrrole-3-carboxylic acid, ethyl 1H-pyrrole-2-carboxylate, 2,4,-dimethyl-pyrrole-3-carboxylic acid, [4-(1H-Pyrrol-1-yl)phenyl]methanol, 1-(4-Nitrophenyl)pyrrole, 2-(2,5-Dimethyl-1H-pyrrol-1-yl)benzonic acid, Methyl 1,2,5-trimethyl-1H-pyrrole-3-carboxylate, methyl 4-amino-1-methyl-1H-pyrrole-2-carboxylate, 1-(2-hydroxyethyl)imidazole, 1-ethyl-imidazole, 1-(3-Aminopropyl)imidazole, 2-(Aminomethyl)imidazole, 4(5)-(Hydroxymethyl)imidazole, 2-pentyl-imidazole, 1-(3-Aminopropyl)-2-methyl-1H-imidazole, 4-nitroimidazole, 2-(diethoxymethyl)imidazole, (1-methyl-1H-imidazol-2-yl)methanol, 4-tert-Butyl-imidazole, imidazole-4,5-dicarboxylic acid, imidazole-2-carboxylic acid, 1,4-dimethyl-imidazole-5-carboxylic acid, methyl 1H-imidazole-1-carboxylate, 1-methyl-1H-imidazole-2-carboxylic acid, histidine, i-dodecylimidazole, 2-(1H-imidazol-2-yl)pyridine, 1-benzyl-5-hydroxymethyl-imidazole, 4-(1H-imidazol-1-yl)aniline, 4-methyl-2-(2-pyridinyl)imidazole-5-carboxylic acid, 1-(4-methoxyphenyl)imidazole, 2-(aminomethyl)thiazole, 4-(chloromethyl)thiazole, 2-methyl-1,3-thiazole, thiazole-5-carboxamide, ethyl 2-(2-thienyl)thiazole-4-carboxylate, thiazole-2-carboxylic acid, ethyl-2-(2-thienyl)thiazole-4-carboxylate, 2-(4-pyridyl)thiazole-4-carboxylic acid, 2-amino-4-(4-nitrophenyl)thiazole, 3-(1,3-thiazol-2-yl)benzoic acid, 2-amino-4-(2-thientyl)thiazole, and 2-amino-4-(2-furyl)thiazole.

In some examples of type formula I, R₁ and R₂ are taken together, with intervening atoms, to form a carbocycle, heterocycle, substituted carbocycle, or substituted heterocycle. In some implementations of these examples the formula I compound may be: 6-(aminomethyl)indole, indole-3-acetic acid, indole-2-methanol, methyl indole-5-carboxylate, indole-3-carboxylic acid, ethyl indole-3-carboxylate, indole-3-acetamide, 2-bromo-1-methylbenzimidazole, indole-3-pyruvic acid, 5-(methoxycarbonyl)indole-2-carboxylic acid, tryptophan, 5-(benzyloxy)indole, 3,5,7-trimethyl-1H-indole-2-carboxylic acid, carbazole, 3-benzyl-1H-indole, 3,3′-diindolymethane, 1-methyl-6-nitro-1H-dinole, 3-(N-methylpiperidinyl)indole, methyl 6H-thieno[2,3-b]pyrrole-5-carboxylate, or methyl 4H furo[3,2-b]pyrrole-5-carboxylate.

In some examples of type formula I, R₂ and R₃ are taken together, with intervening atoms, to form a carbocycle or substituted carbocycle. In some implementations of these examples, the formula I compound maybe: benzo[c]thiophene, benzo[d][1,2,3]thiadiazole, benzo[c][1,2,5]thiadiazole, isoindole, benzotriazole, methyl-1H-benzotriazole, benzo[c][1,2,5]oxadizaole, or methyl 2-aminobenzo[d]thiazole-5-carboxylate.

In some examples of type formula I, R₁ and R₂ are taken together, with intervening atoms, to form a carbocycle, or substituted carbocycle, and R₃ and R₄ are taken together, with intervening atoms, to form a carbocycle or substituted carbocycle. In some implementations of these examples, the compound may be: carbazole, 9H-carbazole-9-ethanol, 2,3,4,9-Tetrahydro-1H-carbazole-1-carboxylic acid, 9-Methyl-9H-carbazole-3-carboxylic acid, 3-Methoxy-9H-carbazole, 3-Bromo-9H-carbazole.

In some examples of type formula I, the aromatic compound exists as an acid. In some examples of type formula I, the aromatic compound may exist as a conjugate base in various salt forms with one or more counterions. Examples of salt counterions include lithium, sodium, potassium, rubidium, cesium, magnesium, calcium, strontium, barium, manganese, iron, cobalt, nickel, copper, zinc, aluminum, gallium, molybdenum, silver, platinum, tin, ammonium, ammonium organic compounds.

In some variations, the aromatic compound may be an aromatic compound represented by formula II:

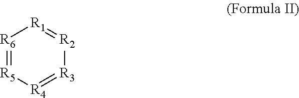

or the salts, or tautomers thereof. In Formula II, R₁-R₆ may each be independently selected from CR_{C}, N; and R_{C} may be independently selected from H, F, Cl, Br, OH, NH2, NO2, CN, CHO, C₁-C₂₀-alkyl, C₁-C₂₀-hydroxyalkyl, C₁-C₂₀-alkyl ether, C₁-C₂₀-aminoalkyl, C₁-C₂₀-alkyl carboxylic acid, C₁-C₂₀-aminoalkyl carboxylic acid, C₁-C₂₀-alkyl carboxamide, C₁-C₂₀-alkenyl which contains 1, 2, 3, 4, or 5 double bonds, alkyls partially substituted with carbocycles or heterocycles, alkyls fully substituted with carbocycles or heterocycles, and an option wherein R₁ and R₂ are taken together, with intervening atoms, to form a carbocycle, a heterocycle, a substituted carbocycle, or a substituted heterocycle. Substitutions off the carbocycle or heterocycle formed by pairing of R1 and R2, may include H, F, Cl, Br, OH, NH2, NO2, SO3H, CN, CHO, C1-C20-alkyl, C1-C20-hydroxyalkyl, C1-C20-alkyl ether, C1-C20-aminoalkyl, C1-C20-alkyl carboxylic acid, C1-C20-aminoalkyl carboxylic acid, C1-C20-alkyl carboxamide, C1-C20-alkenyl which contains 1, 2, 3, 4, or 5 double bonds. The formula components of R₁-R₆ and R_{c} may be selected from sets consisting of the options described above or any subset of options described herein.

Examples of compounds of type formula II may include: benzoic acid, toluic acid, dimethylaminobenzoic acid, phenylnitrile, phenyl nitrite, phenyl nitrate, phenylacetaldehyde, benzaldehyde, fluorobenzoic acid, iodobenzoic acid, chlorobenzoic acid, bromobenzoic acid, phenyl sulfonic acid nitrobenzoic acid, dihydroxy-benzoic acid, hydroxybenzoic acid, aminobenzoic acid, methoxybenzoic acid, ethoxybenzoic acid, 11-phenylundecanoic acid, 13-phenyltridecanoic acid, 15-phenylpentadecanoic acid,

15-phenylpentadec-9-enoic acid, crassinervic acid, capsiacin, 13-Phenyltridec-9-enoic acid, chlorosalicyclic acid, bromosalicyclic acid, salicylic acid, cinnamic acid, pyridine, 3,5-lutidine, phenylalanine, tyrosine, 5-phenyltetrazole, coumaric acid, caffeic acid, sinapic acid, chlorogenic acid, rosmarinic acid, ferulic acid, 3,4,5,-trihydroxycinnamic acid, phenylmethylamine, phenylethylamine, ethylene glycol monophenyl ether, phenylpropylamine, phenol, biphenyl carboxylic acid, hydroxybiphenyl, hydroxychlorobiphenyl, ethyl phenyl ether, propylene glycol phenyl ether, styrene glycol, 2-anilinoethanol propylbenzene, toluene, hexylbenzene, dodecylbenzene, 4-phenylbutan-1-ol, phenethyl alcohol, 4-phenylpropan-1-ol, phyenylmethanol, (methoxymethyl)benzene, (propoxymethyl)benzene, (hexyloxymethyl)benzene, ((3-ethoxypropoxy)methyl)benzene, cyclohexyl phenyl ether, phenoxybenzene, 5-phenoxynonane, aniline, N-methylaniline, N,N-dimethylaniline, phenylmethanamine, 4-phenylbutan-1-amine, N-phenylacetamide, N-phenylpropionamide benzamide, N-methylbenzamide, N-ethylbenzamide, 1-Hexadecylpyridinium bromide, 2-hydroxynicotinic acid, 4,4-dibromo-2,2-bipyridine, picoline, niacin, pyridine carboxylic acid, pyridine dicarboxylic acid, (2-chloro-3-pyridinyl)methanol, 2-amino-3-pyridinecarboxaldehyde, 3-Pyridylacetic acid, N-Methyl-4-chloropyridine-2-carboxamide, Ethyl picolinate, 2,6-pyridinedimethanol, Methyl 6-aminonicotinate, 5-hydroxynicotinic acid, 2-amino-6-methoxypyridine, 2-methoxy-5-nitropyridine, pyridazine, pyrimidine, uracil, thymine, cytosine, 1-benzyl-5-hydroxymethyl-1H-imidazole, 4-(1H-imidazol-1-yl)aniline, 2-(1H-imidazol-2-yl)pyridine, 1-(40methoxyphenyl)-1H-imidazole, pyrimidinecarboxylic acid, 2,2′-bipyrimidine, 2-methanesulfonyl-pyrimidine, 2-Amino-6-methyl-3-nitropyridine, 3,6-Dihydroxy-4-methylpyridazine, 3,6-Dichloro-4-methylpyridazine, 3-Chloro-6-(p-tolyl)pyridazine-4-carboxylic acid, serpentene.

In some examples of type formula II, R₁ and R₂ are taken together, with intervening atoms, to form a carbocycle, heterocycle, substituted carbocycle, or substituted heterocycle. In some implementations of these examples, the formula II compound may be: quinoline, isoquinoline, 4-aminomethyl quinoline, 8-methyl-quinoline-3-carboxylic acid, naphthalene, 2-Naphthoic acid, tryptophan, tolytriazole, indole-3-carboxylic acid, benzimidazole, benzotriazole, 6-(aminomethyl)indole, indole-3-acetic acid, indole-2-methanol, methyl indole-5-carboxylate, ethyl indole-3-carboxylate, indole-3-acetamide, 2-bromo-1-methylbenzimidazole, indole-3-pyruvic acid, 5-(methoxycarbonyl)indole-2-carboxylic acid, tryptophan, 5-(benzyloxy)indole, 3,5,7-trimethyl-1H-indole-2-carboxylic acid, carbazole, 3-benzyl-1H-indole, 3,3′-diindolymethane, 1-methyl-6-nitro-1H-dinole, 3-(N-methylpiperidinyl)indole, methyl 6H-thieno[2,3-b]pyrrole-5-carboxylate, benzo[c]thiophene, benzo[d][1,2,3]thiadiazole, benzo[c][1,2,5]thiadiazole, isoindole, methyl-1H-benzotriazole, benzo[c][1,2,5]oxadizaole, methyl 2-aminobenzo[d]thiazole-5-carboxylate, 9H-carbazole-9-ethanol, 2,3,4,9-Tetrahydro-1H-carbazole-1-carboxylic acid, 9-Methyl-9H-carbazole-3-carboxylic acid, 3-Methoxy-9H-carbazole, 3-Bromo-9H-carbazole, or 2,6-naphthalenedicarboxylic acid, 3-Bromo-6-methoxy-2-methylimidazo[1,2-b]pyridazine.

In some examples of type formula II, the aromatic compound exists as an acid. In some examples of type formula II, the aromatic compound may exist as a conjugate base in various salt forms with one or more counterions. Examples of salt counterions include lithium, sodium, potassium, rubidium, cesium, magnesium, calcium, strontium, barium, manganese, iron, cobalt, nickel, copper, zinc, aluminum, gallium, molybdenum, silver, platinum, tin, ammonium, ammonium organic compounds.

As discussed, the composition may include multiple types of aromatic compounds as such the aromatic compound could, for example, include multiple types of aromatic compounds of type formula I and/or formula II. For example, one composition may include one type of formula I and one type of formula II.

In some variations, the composition may include a buffer compound. Depending on the state of the composition, the buffer compound may comprise a buffer in solution (e.g., in water or in glycol) or a buffer salt. A buffer may generally comprise a weak acid and its conjugate base or a weak base and its conjugate acid with a pKa between 2 and 12. In many variations, the buffer comprises a compound with a pKa between 6 and 12. A buffer can function in an implementation pH near the pKa. This is not to say that the implementation of the composition is limited to the pH range provided by the buffer, but that the composition may have better functionality in that range. In some variations, multiple buffer compounds may be combined to perform as the buffer.

Examples of possible buffers include: carbonate, borate salts, bicarbonate, monoethanolamine, diisopropylamine, monoisopropanolamine, butylethanolamine, octanolamine 2-amino-2-methyl-1-propanol, ammonium hydroxide, ammonia, diethylammonium, methylammonium, diglycolamine, triethanolamine, tromethamine, dimethylaminoethanol, tricine, citrate, succinate, phosphate, polyphosphate, piperidine, piperazine, tris(hydroxymethyl)aminomethane (Tris), bis-tris methane (Bis-tris), N-(2-acetamide)-2-aminoethane sulfonic acid (ACES), N-(2-acetamide)iminodiacetic acid (ADA), silicate, metasilicate, polysilicate, diglycine, 2-morpholinoethanesulfonic acid (MES), 3-morpholinopropanesulfonic acid (MOPS), piperazine-N,N′-bis(2-ethanesulfonicacid) (PIPES), 2-[4-(2-hydroxyethyl)-1-piperazinyl]ethanesulfonic acid (HEPES), 2-hydroxy-3-[4-(2-hydroxyethyl)-1-piperazinyl]propanesulfonic acid (HEPPSO), and 3-[4-(2-hydroxyethyl)-1-piperazinul]propanesulfonic acid (EPPS) and the respective conjugate acid or base for each possible buffer.

Dependent on implementation, the buffer compound may be included in varying proportions ranging from trace amounts (e.g., 0.1%) to 80%, by weight, of the composition. For example a borate salt may be between 0.1% to 80%. A buffer may alternatively not be included. In one example, the buffer compound comprises a borate compound (e.g. sodium borate, potassium borate, borax). In another example, the buffer compound may comprise a carbonate salt (e.g. sodium carbonate, potassium carbonate). In another example, the buffer compound may comprise triethanolamine. In another example, the buffer compound may comprise a bicarbonate salt (e.g. sodium hydrogen carbonate). In another example, the buffer compound may comprise an amine. In another example, the buffer compound may comprise monoethanolamine. In another example, the buffer compound may comprise ammonium hydroxide. In another variation, the buffer compound may comprise a citrate salt (e.g. trisodium citrate).

In some variations, the composition may include the buffer compound or more specifically a borate compound in place of the aromatic compound. Such a composition similar was discovered to exhibit synergistic corrosion inhibition performance. Accordingly, a composition may include a combination of an organic compound with carboxylic functional group and a borate compound and its combinations. Such combinations may have particular applications as a corrosion inhibitor for galvanized steel.

In some variations, the composition may include a metal treatment additive. This may be particularly the case for treated steel variations (e.g., galvanized steel). As part of these variations, the metal treatment additive may be part of the additional treatment. As one variation, the composition including an organic compound with carboxylic functional group and a borate compound may further include a metal treatment additive. The metal treatment additive may function as a water-soluble metal ion. The metal treatment additive may comprise approximately 0.1% to 10% of the composition. Depending on implementation, the metal treatment additive may be in a liquid (e.g., molten zinc or a zinc chloride solution) or solid (e.g., magnesium salt) state. Examples of metal treatment additives include, zinc or a zinc salt, nickel or a nickel oxide or a nickel salt, tin(II) or a tin(II) salt, tin(IV) or a tin(IV) salt, or magnesium or a magnesium salt.

Depending on implementation, the composition may include other compounds that further enhance or improve its functionality. That is, the composition may include compounds to: improve stability, improve corrosion control, mitigate scale formation, prevent microbial growth, modify the system pH, and the like. Examples of such additives could include glycols, antimicrobial compounds, algaecides, antiscalants, surfactants/detergents, primers/sealants, additional corrosion inhibitors, acids/bases, oxygen scavengers, indicator dyes, additional buffer components, and/or metals (zinc/tin/nickel).

In one variation, for improved corrosion control, the composition may further include: an additional compound selected from Formula I, an additional compound selected from Formula II, sodium molybdate, sodium nitrite, sodium nitrate, oximes, carboxylic acids or mixtures of carboxylic acids and their salts (e.g. C₂-C₂₀ aliphatic dibasic acids including sebacic acid, C₂-C₂₀ aliphatic monobasic acids including 2-ethylhexanoic acid, citric acid, gluconic acid, glucoheptonic acid, galacturonic acid, glucuronic acid, n-keto-acids, lactic acid, acetic acid, formic acid, oxalic acid, uric acid), lactones of carboxylic acids and their salts, glucose oxidation mixtures (glucose oxidation product, a gluconic acid oxidation product, a gluconate, or a combination thereof), carboxylic acid polymers or co-polymers (e.g. polymacrylates, acrylic acid-2-acrylamido-2-methylpropane sulfonic acid), benzotriazole including substitutions off the ring structure, filming amines (e.g. morpholine, octadecylamine, cyclohexylamine, ethanolamine, diethylaminoethanol, dimethlyisopropanolamine, stearyl dipropylene triamine, hexadecylamine, tetradecylamine, oleylamine, N-oleyl-1,3-diaminopropane), tannins, tannin extracts, purified tannins, an amino acid (e.g. cysteine, glycine, histidine, tryptophan, tyrosine), phosphate-derivatives (e.g. aminotrimethylene phosphonic acid, 1-hydroxyethylidene-1, 1-diphosphonic acid, 2-hydrophosphonocarboxylic, polyamino polyether phosphonate, diethylenetriamine penta methylene phosphonic acid, Methylene Phosphonic Acid, 2-phosphonobutane-1,2,4-tricaboxylic acid) and silicates including sodium silicate and polysilicates.

In another variation, for improved scale control, the composition may further include: acrylate polymers, polymaleic polymers, and other dispersant polymers including copolymers, sulfonated polymers, and multipolymers, polydiols, and phosphonates (e.g. i-hydroxyethylidene 1,1-diphosphonic acid, 2-phosphonobutane-1,2,4-tricarboxylic acid).

In another variation, for microbial growth inhibition or algae growth inhibition, the composition may further include: peroxide, sodium or calcium hypochlorite, sodium chlorite, chlorine, bromine, sodium bromide, bromine chloride, diquat dibromide, bromochloro-hydantoins, chlorine dioxide, persulfates, permanganates, peracetic acids, ozone, chloramines, biofilm dispersants, terbuthylazine, quaternary ammonium salts, beta-bromo-beta-nitrostyrene, bromonitro-propanediol, dibromo-nitrilo-propionamide, methylene bis thiocyanate, isothiazolone, dodecylguanidine, glutaraldehyde, carbarnates, copper sulfate, silver nitrate, silver chloride, 5-chloro-2-methyl-4-isothiazolin-3-one, 2-methyl-4-isothiazolin-3-one.

In another variation, the composition may further include a detergent or surfactant. Non-limiting examples of surfactants include nonionic surfactants, ionic surfactants, amphoteric surfactants, and combinations thereof. In a further aspect, the surfactant comprises one or more functional groups including, but not limited to, alkoxylates, polyalkoxylates, ethoxylates, ethoxylated alcohols, polyethoxylates, glucosides, fatty acid salts, sulfates (including alkyl, aryl or alkylaryl variants), sulfonates (including alkyl, aryl or alkylaryl variants), disulfonates, phosphate esters, sulfosuccinates, quaternary ammonium salts, alkylsulfonic acids, sulfosuccinate salts, or amphiphilic copolymers.

In another variation, for surface treatment, the composition may further include a primer or a sealant used to block passage of fluids through a surface or joint. Non-limiting examples of sealants or primers include: amines, resins, epoxies, acrylic copolymers, silicone, polysiloxane, urethanes, fluoropolymers, polyvinyl compounds siloxanes, polyurethane, polyester, latex, alkyd, or polyurethane.

In another variation, the composition may further include a fluorescent organic compound indicator dye. In certain preferred embodiments, the fluorescent organic compound is selected from the group consisting of Rhodamine, a derivative of Rhodamine, an acridine dye, fluorescein, a derivative of fluorescein, a fluorescent tagged polymer, and combinations thereof.

In another variation, for oxygen scavenging, the composition may further include: sulfite salts, bisulfite salts, metabisulfite salts, thiosulfate salts, hydrazine, carbohydrazide, erythorbic acid, ascorbic acid, tannins, diethylhydroxyl amine, or tetrahydroxy ethylene diamine.

In another variation, for pH adjustment, the composition may further include a metal hydroxide (e.g. sodium hydroxide, potassium hydroxide), an amine (e.g. monoethanolamine, diisopropylamine, monoisopropanolamine, butylethanolamine, octanolamine 2-amino-2-methyl-1-propanol, ammonium hydroxide, ammonia, diethylammonium, methylammonium, diglycolamine, triethanolamine, tromethamine, dimethylaminoethanol) or an acid (e.g. sulfuric acid, sulfamic acid, nitric acid, citric acid, carbon dioxide).

### 2. Example Compositions

As mentioned above, the composition formulation may be highly implementation specific. Herein specific example formulations are presented and their effectiveness as a treatment for carbon steel are shown. These examples are presented only as examples and do not imply any limitations on possible use cases and/or other composition variations. For simplicity of examples, the hydroxy-carboxylic acid is typically galactaric acid, glucaric acid, malic acid, hydroxycitric acid or tartaric acid. Examples of hydroxy-carboxylic acids include:

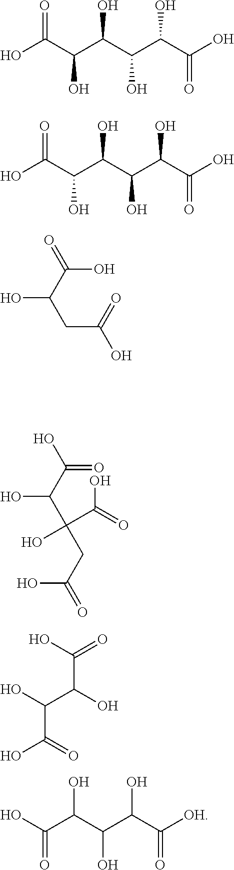

Alternatively it may be any other hydroxy-carboxylic acid or hydroxy-dicarboxylate salt, such as sodium potassium glucarate, xylaric acid, arabinaric acid etc. As mentioned above, depending on the state of the composition components may come in solid or liquid variations. For example, the aromatic compound may comprise: imidazole, indole-3-carboxylic acid, cinnamic acid, or benzoate. For example, the buffer compound borate may comprise: anhydrous sodium borate, or a borate compound (e.g., sodium borate decahydrate, potassium borate tetrahydrate, etc.).

In a first variation the composition comprises: hydroxy-carboxylic acid, with a concentration of approximately 20% to 85% of the composition; an aromatic compound, with a concentration of approximately 15% to 80% of the composition; and a buffer compound, comprising a borate compound, with a concentration of approximately 0% to 60% of the composition.

In a first example of the first variation of the composition, the hydroxy-carboxylic acid comprises 40%-60% tartaric acid, the aromatic compound comprises 20-45% imidazole, and the buffer component comprises 4%-25% borate.

In a second example of the first variation of the composition, the hydroxy-carboxylic acid comprises 45%-75% tartaric acid, and the aromatic compound comprises 25%-65% imidazole.

In a third example of the first variation of the composition, the hydroxy-carboxylic acid comprises 45%-75% tartaric acid, and the aromatic compound comprises 25%-55% indole-3-carboxylic acid.

In a fourth example of the first variation of the composition, the hydroxy-carboxylic acid comprises 45%-75% tartaric acid, and the aromatic compound comprises 25%-55% cinnamic acid.

In a fifth example of the first variation of the composition, the composition includes an amino acid polymer alternate, comprising 40%-60% polyaspartic acid, the aromatic compound comprises 20%-45% imidazole, and the buffer component comprises 4%-25% borate.

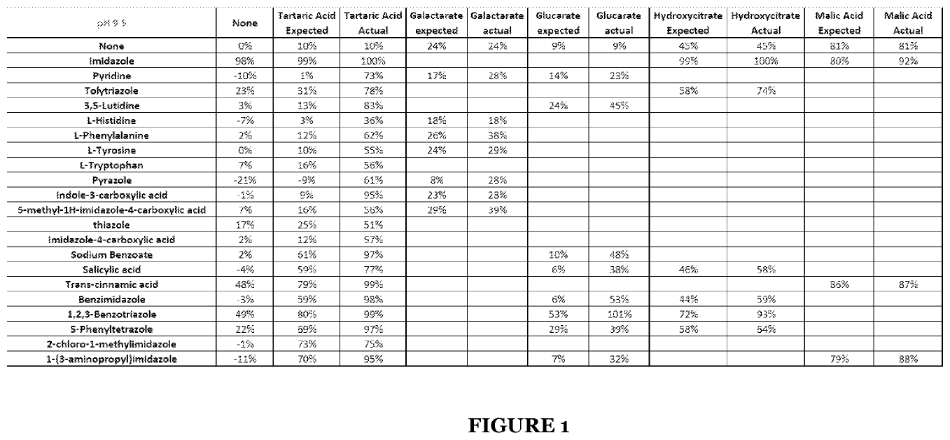

FIG. 1 shows a general summary of the first variation examples for a carbon metal treated with different hydroxy-carboxylic acids and various aromatic compounds. In this example, compositions were dissolved in tap water at 200 ppm of carboxylic acid and 133 ppm of aromatic compound and the resulting weight loss from a carbon steel coupon was measured after 7 days. The corrosion inhibitor efficiency calculates the percent reduction in mass loss from a carbon steel coupon for varying formulations calculated from a baseline 32 mg loss for untreated carbon steel coupons after 7 days in tap water. Expected corrosion inhibition efficiency was calculated assuming the effects of the acid and the aromatic compounds are multiplicative. As shown in FIG. 1, the hydroxy-carboxylic acids including tartaric acid, galactaric acid, glucaric acid, hydroxycitric acid, and malic acid show a surprising synergy in combination with many different aromatic compounds that reduces corrosion. Examples of Formula I aromatic compounds synergistically reducing corrosion as shown in FIG. 1 include imidazole, tolytriazole, L-histidine, L-tryptophan, pyrazole, indole-3-carboxylic acid, 5-methyl-1H-imidazole-4-carboxylic acid, thiazole, imidazole-4-carboxylic acid, benzimidazole, 1,2,3-benzotriazole, 5-phenyltetrazole, 2-choloro-1-methylimidazole. Examples of Formula I aromatic compounds include:

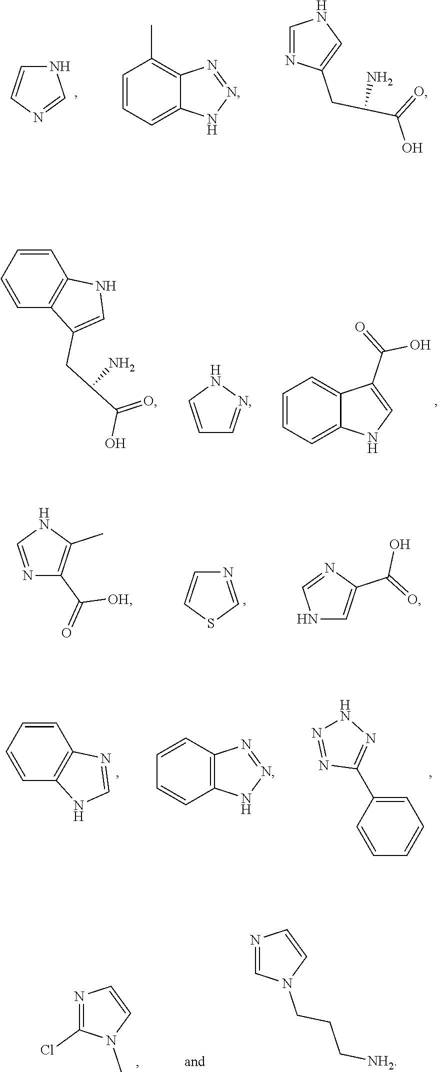

Examples of Formula II aromatic compounds synergistically reducing corrosion as shown in FIG. 1 include pyridine, tolytriazole, 3,5-lutidine, L-phenylalanine, L-tryosine, L-tryptophan, indole-3-carboxylic acid, sodium benzoate, salicyclic acid, trans-cinnamic acid, benzimidazole, 1,2,3-benzotriazole, 5-phenyltetrazole. Examples of Formula II aromatic compounds include:

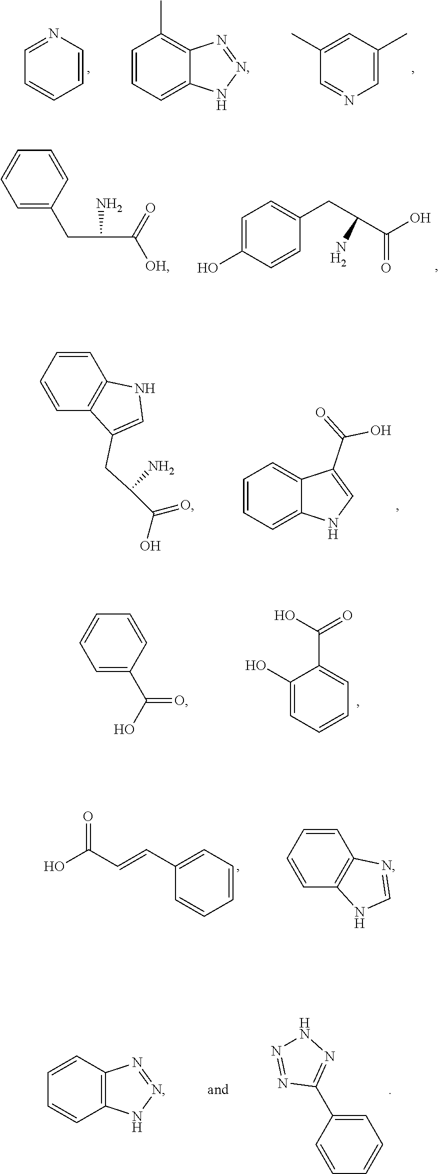

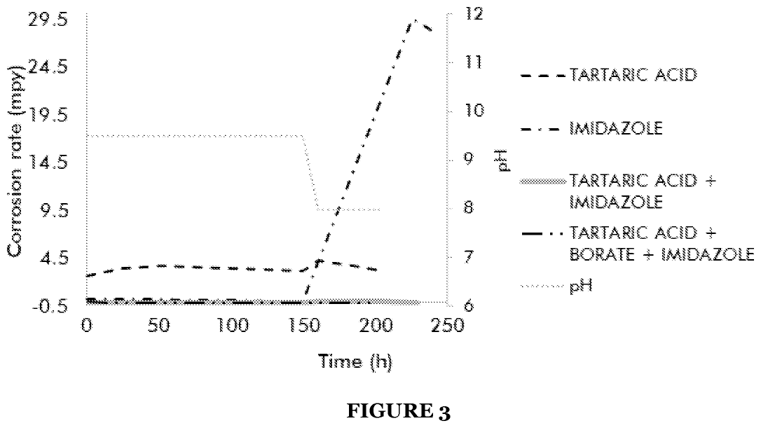

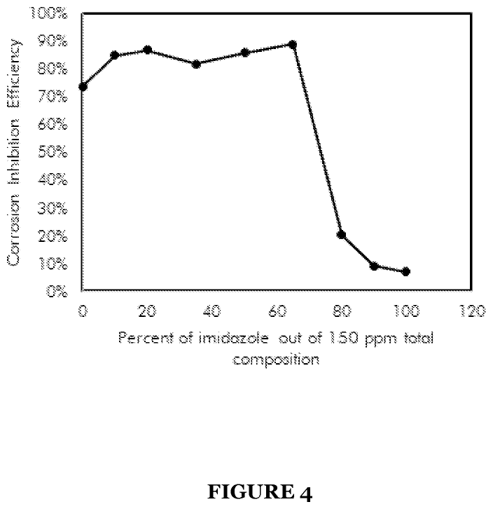

FIG. 3 demonstrates an unexpected synergy in carbon steel corrosion inhibition for the first variation of compositions including the hydroxy-carboxylic acid and an aromatic compound. As shown in FIG. 3, individual chemical components or mixtures were dissolved in tap water and the pH was adjusted to 9.5 with sodium hydroxide. Linear polarization electrodes were added to continually stirred solutions and the corrosion rate was monitored. After 150 hours at pH 9.5, the pH of each solution was lowered to pH 8 with sulfuric acid. Formulations comprising tartaric acid and imidazole show corrosion below the desired 0.1 MPY across all time points and pH. In contrast tartaric acid or imidazole individually at the same concentrations show much greater corrosion at pH 8. Another demonstration of the unexpected synergy in carbon steel corrosion inhibition is shown in FIG. 4 for compositions comprising tartaric acid and imidazole. In FIG. 4, carbon steel coupons were incubated in tap water with 160 ppm sodium chloride for 48 hours with 150 ppm total composition of different ratios of tartaric acid and imidazole at pH 9.5. Mixtures of tartaric acid and imidazole show synergistic improved corrosion inhibition compared to either tartaric acid or imidazole alone at 150 ppm for ranges from 10% imidazole through 65% imidazole.

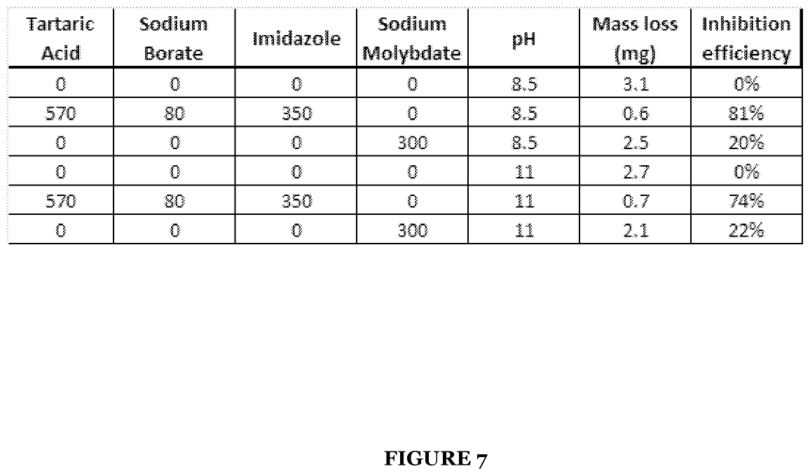

FIG. 7 demonstrates efficacy for the first variation of compositions in inhibiting corrosion of aluminum metal at pH 8.5 and pH 11 compared to no treatment or treatment with 300 ppm of sodium molybdate.

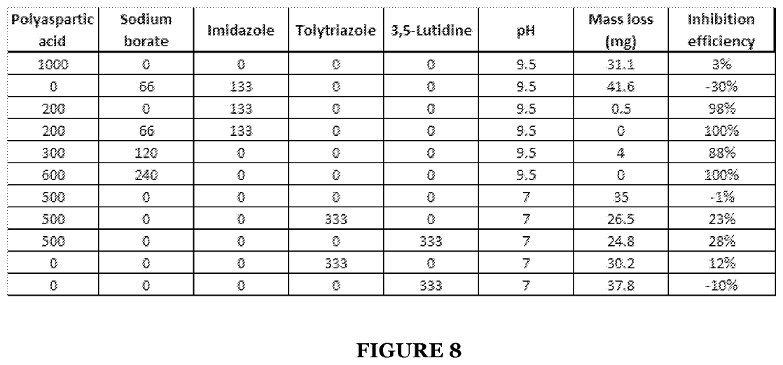

In a second variation, as shown in FIG. 8, the composition may include an amino acid polymer alternate (i.e., polyaspartate (PASP)) with an imidazole aromatic compound and/or with a borate buffer component. FIG. 8 shows a table of example compositions for corrosion inhibition that include polyaspartic acid. In these examples, compositions were dissolved in tap water at the indicated concentration (in ppm) and the resulting weight loss from a carbon steel coupon was measured after 7 days. The corrosion inhibitor efficiency for varying concentration of components for a carbon steel coupon after 7 days at pH 9.5 or pH 7 is shown. The examples that include PASP with imidazole, and/or borate show a surprising synergic reduction in corrosion resulting in little to no corrosion. Additionally, examples with tolytriazole or 3,5-lutidine also show a surprising synergic reduction in corrosion at pH 7.

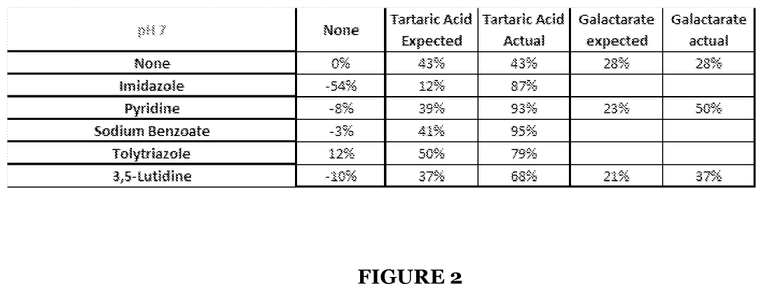

In a third variation, as shown in FIG. 2, the composition includes both the hydroxy-carboxylic acid component, tartaric acid or galactaric acid, and the aromatic compound, sodium benzoate, imidazole, 3,5-lutidine, or tolytriazole at pH 7. FIG. 2 is a table of example compositions for corrosion inhibition at pH 7. Compositions were dissolved in tap water at 500 ppm of acid and 333 ppm of aromatic compound and the resulting weight loss from carbon steel coupon was measured after 7 days. The corrosion inhibition efficiency was calculated from 34.5 mg loss for untreated carbon steel coupons in tap water. Expected corrosion inhibition efficiency was calculated assuming the effects of the acid and the aromatic compounds are multiplicative. Tartaric acid in combination with benzoate, imidazole, 3,5-lutidiene, or tolytriazole shows a surprising and synergic reduction in corrosion and galactaric acid shows a surprising and synergic reduction in corrosion in combination with pyridine or 3,5-lutidiene.

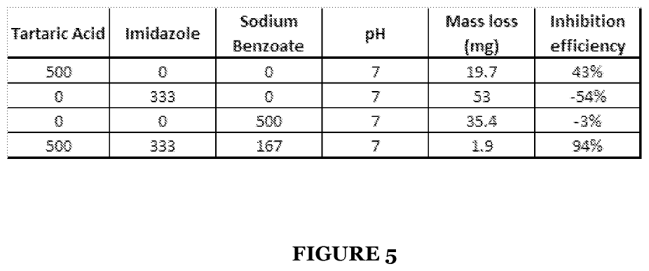

In a fourth variation, the composition includes the hydroxy-carobxylic acid component, tartaric acid, and two aromatic compounds, sodium benzoate (from Formula II) and imidazole (from Formula I) at pH 7. FIG. 5 is a table of example compositions for corrosion inhibition at pH 7. Compositions were dissolved in tap water at the indicated ppm and the resulting weight loss from carbon steel coupon was measured after 7 days. The corrosion inhibition efficiency was calculated from 34.5 mg loss for untreated carbon steel coupons in tap water.

In a fifth variation, the composition comprises the corrosion inhibitor composition and further comprises a glycol or a glycol ether. Examples of glycols include, but are not limited to, propylene glycol, ethylene glycol, 1,3-propanediol, 1,2-propanediol, butylene glycol, 1,2-butanediol, 1,4-butanediol, and polymers of glycols such as polyethylene glycol. Examples of glycol ethers include, but are not limited to, ethylene glycol ethyl ether, diethylene glycol ethyl ether, triethylene glycol ethyl ether, ethylene glycol methyl ether, diethylene glycol methyl ether, triethylene glycol methyl ether, polyethylene glycol methyl ether, ethylene glycol butyl ether, diethylene glycolbutyl ether, triethylene glycol butyl ether, polyethylene glycol butyl ether, dipropylene glycol methyl ether, polypropylene glycol methyl ether, and a mixture thereof. Glycols are commonly included in systems that may be subject to temperatures below freezing. In this embodiment, the composition comprises: a hydroxy-carboxylic acid, with a concentration of approximately 0.1% to 5% of the composition; and an aromatic compound, with a concentration of approximately 0.05% to 5% of the composition; and a buffer compound, with a concentration of approximately 0-5%; and a glycol compound with a concentration of approximately 20-99%. In some variations, this composition may be dissolved in water to make up the remaining solution.

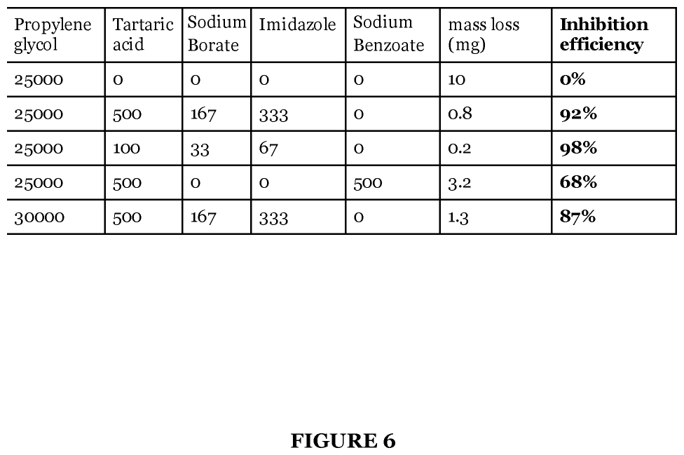

Shown in FIG. 6 are compositions in solution dissolved in water at the indicated ppm, wherein the hydroxy-carboxylic acid comprises tartaric acid, the aromatic compound comprises imidazole or benzoate, the buffer compound comprises borate, and the glycol compound comprises propylene glycol. As shown in the table, for a carbon steel object treated with the composition, after 7 days, the least amount of corrosion was seen for tartaric acid concentrations from approximately 0.1% to 0.5%. In one variation of the composition, the hydroxy-carboxylic acid comprises tartaric acid, with a concentration of approximately 0.1% to 1% of the composition; the aromatic compound comprises imidazole, with a concentration of 0.05-1%; and the buffer compound comprises borate, with a concentration of 0.0%-0.5% of the composition. As shown in FIG. 6, this composition maintains greatly lower corrosion compared with the composition containing only propylene glycol.

### 3. Method

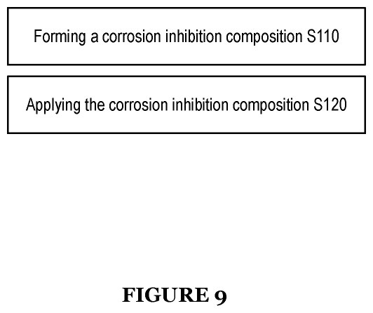

As shown in FIG. 9, a method for corrosion protection comprises: forming a corrosion inhibition composition S110 and applying the corrosion inhibition composition S120. The method functions to provide, or enhance, corrosion resistance of different types of metal.

The corrosion inhibition composition is preferably one of the variations described herein. As such the method leverages the synergistic properties for corrosion inhibition resulting from the composition that is a combination including an organic compound with carboxylic functional group.

The method variations may be used within closed fluid systems or open fluid systems. Closed fluid systems are generally characterized as closed loop fluid systems that have low rates of water/solution loss/replacement over a given time period (e.g., a year). Open systems may have the water used within the system change (leaving and being added). The method may have various potential benefits over existing solutions like nitrites, molybdates, phosphates, and phosphonates. The method can enable use of a biodegradable composition that is low cost and with more expanded operating conditions.

In a first variation, a method for corrosion protection may include forming a corrosion inhibition composition S110, the corrosion inhibition composition comprising: 20-85% of an organic compound with a carboxylic functional group, and 15-80% of an aromatic compound; and applying the corrosion inhibition composition (S120) within a fluid system.

In second variation, a method for corrosion protection, which may be used for protecting galvanized steel, may include forming a corrosion inhibition composition S110, the corrosion inhibition composition comprising 20-80% of an hydroxydicarboxylic acid or salt thereof, and 20-80% of a borate compound; and applying the corrosion inhibition composition (S120) within a fluid system with exposed galvanized steel. This composition uses the combination of a hydroxydicarboxylic, a borate compound and optionally a water soluble metal ion (zinc, tin, nickel, magnesium) to mitigate white rust formation and corrosion of galvanized steel.

This method may include dissolving components of the composition in an aqueous solution and applying that solution to the surface of galvanized steel. The fluid system has an operating pH of 7-12. Additionally applying the corrosion inhibition composition within a water system with exposed galvanized steel may include applying the corrosion inhibition composition within the water system comprises dissolving the corrosion inhibition composition with a concentration 50-5000 ppm within a solution of the fluid system. This may be used in prolonging the life of capital equipment susceptible to corrosion such as cooling towers using galvanized steel. The use of the composition may also expand the “safe” operating range for protection of galvanized steel (e.g., higher pH, less calcium carbonate, higher chloride). Cooling towers and open fluid systems and general may be particularly challenging as the water may be evaporated to eject heat from the system. This concentrates all ions and chemicals in the water which can traditionally increase corrosion. The method and application of the composition described herein can help in mitigating corrosion and can help with the zinc coating providing protection over expanded operating conditions such as pH greater than 8.5, water containing high sulfates, or water with low hardness thereby mitigating such cases of corrosion.

The method may be highly dependent on the type of metal, wherein even different types of steels, such as carbon steel, alloy steel, stainless steel, tool steel, may require variations in implementation.

The method may be implemented as a distinct method on its own, or a part of any other method treatment. For example, the method may be incorporated as part of a galvanization process, wherein forming a corrosion inhibition composition S110 may further include combining a zinc composition; and applying the corrosion inhibition composition S120 may further include applying the inhibition composition as part of a galvanization process. In another example, the method may be incorporated in a paint or coating process, wherein forming a corrosion inhibition composition S110 may further include combining a paint or coating composition; and applying the corrosion inhibition composition S120 may further include applying the inhibition composition as part of a paint or coating process. In another example, the method may be to treat the metal surface by dipping the metal into the corrosion inhibition composition Siio. In another example, the method may be incorporated as part of a passivation process, wherein applying the corrosion inhibition composition S120 may be for as short as 10 seconds, 1 minute, 5 minutes, 10 minutes, 30 minutes, 60 minutes, 2 hours, 4 hours, 12 hours, 24 hours, multiple days, one week, one month, or longer before removal of the corrosion inhibition composition with the expectation of continued corrosion inhibition.

Alternatively, the method may be implemented as a complement, or further addition, to a previously implemented corrosion inhibition process. As discussed above, the method, particularly the corrosion inhibition composition, may be specialized to the metal to be treated. For example, in this alternate implementation, the method may comprise a method for treating galvanized steel with a corrosion inhibitor, wherein the corrosion inhibitor contains at least one hydroxycarboxylic acid compound and a borate compound, wherein the hydroxy-carboxylic acid contains at least two carboxylic acids and one or more hydroxyls.

Block S110, which includes forming a corrosion inhibition composition, functions to form or assemble the components of the corrosion composition. The corrosion composition may be constructed in an active or inactive form (e.g., combining dry ingredients).

The corrosion inhibition composition may include the combination of compounds or otherwise facilitating the formation of the corrosion inhibitor composition as described herein that leverages synergistic interactions in a combination involving an organic compound with a carboxylic functional group.

In one exemplary variation, forming the corrosion inhibition composition may include combining a hydroxy-carboxylic acid (or a salt or lactone variation of the hydroxy-carboxylic acid) and an aromatic compound.

In another exemplary variation, depending on the steel type, forming a corrosion inhibition composition may include combining: a hydroxy-carboxylic acid, an aromatic compound and a buffer or a salt variation of the buffer.

In yet another exemplary variation, depending on the steel type, forming a corrosion inhibition composition may include combining: a hydroxy-carboxylic acid and a buffer or a salt variation of the buffer.

In some variations, forming a corrosion inhibition composition may further include combining a poly-amino acid, and/or combining a protective metal (e.g., zinc, nickel, magnesium).

In active formulations, block S110 may further include mixing the formulation in water or a solvent. In other active formulations, block S110 may further include mixing the formulation in a water solution containing a noncarboxylate alkali source. Alkali sources include metal hydroxides and amines (e.g. monoethanolamine, triethanolamine).

Combining a hydroxy-carboxylic acid may include adding an appropriate hydroxy-carboxylic acid to the composition, wherein the hydroxy-carboxylic acid contains two or three carboxylic acids and one or more hydroxyls. In some variations, the hydroxy-carboxylic acid may be an aldaric acid (e.g. galactaric acid, tartaric acid). Examples of hydroxy-carboxylic acids can include: galactaric acid, glucaric acid, xylaric acid, arabinaric acid, tartaric acid, malic acid, and hydroxycitric acid and all stereoisomers, enantiomers, diastereomers of these acids or salts thereof. The hydroxy-carboxylic acids can include the lactone form of the acid such as galactarolactone or glucarolactone. Although specific example hydroxy-carboxylic acids have been named, generally, in addition to other hydroxy-carboxylic acids, any structural or stereoisomers of the hydroxy-carboxylic acids and any salt form of the hydroxy-carboxylic acids may be implemented as desired.

In some variations, block S110 may additionally, or alternatively, include combining an amino acid and/or an amino acid polymer. In some variations, the amino acid and/or amino acid polymer may be combined in combination with the hydroxy-carboxylic acid. In some variations, the amino acid and/or amino acid polymer may be used in place of the hydroxy-carboxylic acid, wherein the amino acid and/or amino acid polymer is combined with an aromatic.

Block S110 may include combining a buffer. Depending on the state of the composition, the buffer compound may comprise a buffer in solution (e.g., in water) or a buffer salt. A buffer may generally comprise a weak acid and its conjugate base or a weak base and its conjugate acid with a pKa between 2 and 12. In many variations, the buffer comprises a compound with a pKa between 6 and 12. A buffer can function in an implementation pH near the pKa. This is not to say that the implementation of the composition is limited to the pH range provided by the buffer, but that the composition may have better functionality in that range. In some variations, multiple buffer compounds may be combined to perform as the buffer. Examples of possible buffers include: carbonate salts, borate compounds (e.g. sodium borate, potassium borate), bicarbonate, monoethanolamine, diisopropylamine, monoisopropanolamine, butylethanolamine, octanolamine 2-amino-2-methyl-i-propanol, ammonium hydroxide, ammonia, diethylammonium, methylammonium, diglycolamine, triethanolamine, tromethamine, dimethylamino ethanol, tricine, citrate, succinate, phosphate, polyphosphate, piperidine, piperazine, tris(hydroxymethyl)aminomethane (Tris), bis-tris methane (Bis-tris), N-(2-acetamide)-2-aminoethane sulfonic acid (ACES), N-(2-acetamide)iminodiacetic acid (ADA), silicate, metasilicate, polysilicate, diglycine, 2-morpholinoethanesulfonic acid (MES), 3-morpholinopropanesulfonic acid (MOPS), piperazine-N,N′-bis(2-ethanesulfonicacid) (PIPES), 2-[4-(2-hydroxyethyl)-1-piperazinyl]ethanesulfonic acid (HEPES), 2-hydroxy-3-[4-(2-hydroxyethyl)-1-piperazinyl]propanesulfonic acid (HEPPSO), and 3-[4-(2-hydroxyethyl)-1-piperazinyl]propanesulfonic acid (EPPS) and the respective conjugate acid or base for each possible buffer. The buffer is preferably pH specific. For example for higher pH (e.g., 9-10) implementations. In one example, the buffer may comprise a borate compound.

Depending on implementation, Block S110 may include combining other compounds that further enhance or improve the functionality of the method. That is, Block S110 may include combining compounds to: improve stability, improve corrosion control, mitigate scale formation, prevent microbial growth, modify the system pH, and the like. Examples of such additives could include glycols, antimicrobial compounds, antiscalants, surfactants/detergents, primers/sealants, additional corrosion inhibitors, acids/bases, oxygen scavengers, indicator dyes, additional buffer components, and/or metals (zinc/tin/nickel).

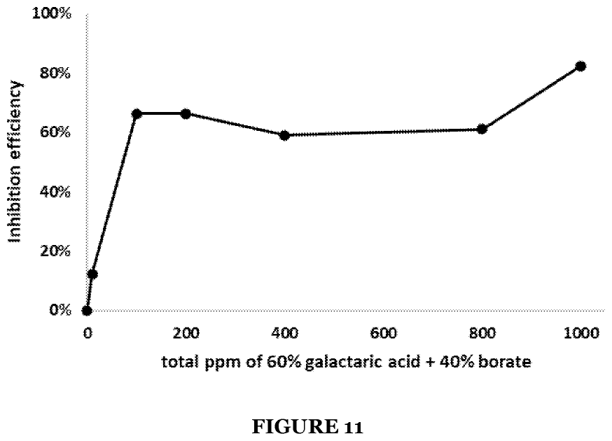

Block S120, which includes applying the corrosion inhibition composition, functions to apply the composition such that corrosion resistance is provided to the metal. In many variations, the applying of the corrosion inhibition composition S120 includes dissolving a sufficient concentration (e.g., as shown in FIG. 11) of the corrosion inhibition composition in water. A metal object may then be placed in the solution and incubated for a sufficient amount of time (e.g., one week). Dependent on implementation the incubation time may correspond to a timespan of minutes, hours, days, weeks, months, or years.

In variations where the method is incorporated as part of another treatment (e.g., galvanization), applying the corrosion inhibition composition S120 may occur concurrent to the other treatment or after the other treatment.

For example, in one variation, the method is applied during a galvanization process. Block S110 may then include forming a corrosion inhibition composition S110 that includes the galvanization components. In one example, molten zinc is combined with an aldaric acid and a buffer. Applying the corrosion composition S120 may then include applying the corrosion composition during galvanization (e.g., hot dipping a metal).

For example, in a second variation, the method is applied during a priming or sealant process. Block S110 may then include forming a corrosion inhibition composition S110 that includes the priming/sealant components. Applying the corrosion composition S120 may then include applying the corrosion composition during surface priming or sealing (e.g., resin or epoxy application).

In one example implementation, for the treatment of galvanized steel, a hydroxy-carboxylic acid, or a salt variation of the hydroxy-carboxylic acid and a buffer or a salt variation of the buffer are combined to form a corrosion inhibition composition; which is then applied to galvanized steels. Depending on implementation, (e.g., on how the steel is galvanized and when it is galvanized compared to application of the composition treatment), the method may further include the addition of zinc. In this embodiment, for a galvanized steel treatment operating at a pH range between 6-12, the corrosion inhibition composition is combined by mixing: a hydroxy-carboxylic acid, with a concentration of approximately 15% to 85% of the composition; and a buffer compound, with a concentration of approximately 15% to 85% of the composition. In some variations, this composition may be combined by dissolving in an aqueous solution which is then applied to the galvanized steel at a concentration of approximately 1-10,000 ppm of the total solution. In another variation, this composition may be combined to form a concentrate by dissolving each component in an aqueous solution containing an amine (e.g. monoethanolamine) at up to 800 g/L of hydroxy-carboxylic acid and up to 800 g/L of a buffer compound. The corrosion inhibition composition may then be applied to the galvanized steel surface by dilution into an aqueous solution with a final concentration of approximately 1-10,000 ppm of the total solution.

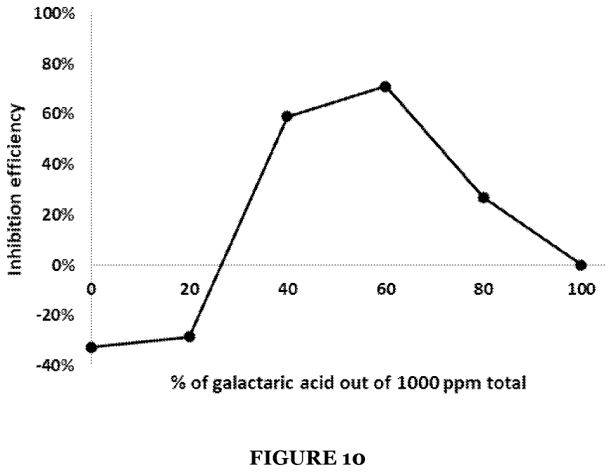

FIG. 10 shows galvanized steel treatments by application of a corrosion inhibition composition in solution at 1000 ppm, wherein the corrosion inhibition compositions include galactaric acid and sodium borate. As shown in FIG. 10, for a galvanized steel object treated in pH 9.5 solution with 3% saline for 7 days with the method, after 7 days, the least amount of corrosion was seen for galactaric acid concentrations from approximately 35% to 65%. This represents an unexpected efficacy for this method in preventing corrosion between the hydroxy-carboxylic acid and buffer components. In one variation of the galvanized steel treatment method, the corrosion inhibition composition is prepared where the hydroxy-carboxylic acid comprises galactaric acid, with a concentration of approximately 55% to 65% of the composition; and the buffer compound comprises borate, with a concentration of 35%-45% of the composition. The combined corrosion inhibition mixture is then applied to galvanized steel at varying final concentrations in solution. As shown in FIG. 11, this method greatly reduces corrosion of the galvanized steel when applied at 100 ppm or greater in the final solution with 3% saline for 7 days.

In a second variation of corrosion inhibition treatment, for galvanized steel, the hydroxy-carboxylic acid comprises galactaric acid, with a concentration of approximately 35% to 45% of the composition; and the buffer compound comprises borate, with a concentration of 55%-65% of the composition.

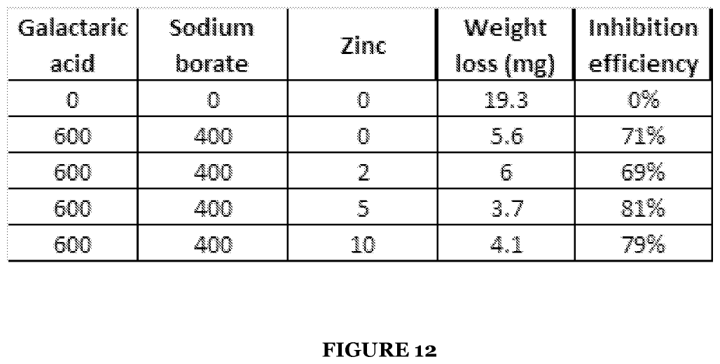

In a third variation of corrosion inhibition treatment, as shown in FIG. 12, for galvanized steel, the method may further include a metal treatment additive comprising approximately 0.1% to 15% of the composition. In FIG. 12, compositions were dissolved in 3% saline solution at pH 9.5 and applied at the indicated ppm to galvanized steel coupons placed in the solution for 7 days. In this variation, combining the corrosion inhibition composition may involve combining: a hydroxy-carboxylic acid comprising galactaric acid, a buffer compound comprising borate, and a metal treatment additive comprising soluble zinc salt. Alternatively, the metal treatment additive may comprise tin(II). Alternatively, the metal treatment additive may comprise nickel.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

1. A corrosion inhibitor composition comprising:
20-85% of at least one hydroxycarboxylic acid with two or three carboxylic functional groups and at least one hydroxyl functional group; and
15-80% of at least one heterocyclic aromatic compound, wherein the at least one heterocyclic aromatic compound comprises a heterocyclic aromatic compound that is represented by the formula: 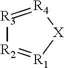
or the salts or tautomers thereof, wherein in the formula of the heterocyclic aromatic compound:
X is selected from NRₐ, S, and O;
R1-R4, each independently are selected from CR_{b} and N;
Rₐ is selected from: H, C₁-C₂₀-alkyl, C₁-C₂₀-hydroxyalkyl, C₁-C₂₀-alkyl ether, C1-C₂₀-aminoalkyl, C₁-C₂₀-alkyl carboxylic acid, C₁-C₂₀-aminoalkyl carboxylic acid, C₁-C₂₀-alkyl carboxamide, C₁-C₂₀-alkenyl containing 1, 2, 3, 4, or 5 double bonds, alkyls partially substituted with carbocycles or heterocycles, and alkyls fully substituted with carbocycles or heterocycles;
R_{b} is independently selected from: H, F, Cl, Br, OH, NH₂, NO₂, CN, CHO, C₁-C₂₀-alkyl, C₁-C₂₀-hydroxyalkyl, C₁-C₂₀-alkyl ether, C₁-C₂₀-aminoalkyl, C₁-C₂₀-alkyl carboxylic acid, C₁-C₂₀-aminoalkyl carboxylic acid, C₁-C₂₀-alkyl carboxamide, C₁-C₂₀-alkenyl which contains 1, 2, 3, 4, or 5 double bonds, alkyls partially substituted with carbocycles or heterocycles, alkyls fully substituted with carbocycles or heterocycles, and an option wherein at least one pair of R1, R2, R3, and R4 are taken together, with intervening atoms, to form a carbocycle, a heterocycle, a substituted carbocycle, or a substituted heterocycle.

2. The composition of claim 1, wherein the hydroxycarboxylic acid is selected from a group consisting of tartaric acid, galactaric acid, glucaric acid, malic acid, and hydroxycitric acid.

3. The composition of claim 1, further comprising 0.1% to 50% of a Borate compound.

4. The composition of claim 1, wherein the organic compound is tartaric acid and comprises 20-85% of the composition; and the aromatic compound is imidazole and comprises 15-80% of the composition.

5. (canceled)

6. (canceled)

7. The composition of claim 1, wherein the composition is dissolved in solution to 10-5000 ppm.

8. The composition of claim 1, further comprising at least one additive from a group consisting of antimicrobial compounds, antiscalants, surfactants/detergents, primers/sealants, acids/bases, oxygen scavengers, indicator dyes, additional buffer components, and/or metal salts.

9. The composition of claim 1, wherein the at least one heterocyclic aromatic compound further comprises a second heterocyclic aromatic compound that is represented by the formula: 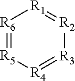
or the salts or tautomers thereof, wherein in the formula of the aromatic compound:
R1-R6 are each independently selected from CRc and N; and
wherein Rc is independently selected from: H, F, Cl, Br, OH, NH2, NO2, CN, CHO, C1-C20-alkyl, C1-C20-hydroxyalkyl, C1-C20-alkyl ether, C1-C20-aminoalkyl, C1-C20-alkyl carboxylic acid, C1-C20-aminoalkyl carboxylic acid, C1-C20-alkyl carboxamide, C1-C20-alkenyl which contains 1, 2, 3, 4, or 5 double bonds, alkyls partially substituted with carbocycles or heterocycles, alkyls fully substituted with carbocycles or heterocycles, and an option wherein R1 and R2 are taken together, with intervening atoms, to form a carbocycle, a heterocycle, a substituted carbocycle, or a substituted heterocycle.

10. A corrosion inhibitor composition comprising:
20-85% of a hydroxycarboxylic acid with two or three carboxylic functional groups and at least one hydroxyl functional group; and
15-80% of an aromatic compound, wherein the aromatic compound is represented by a formula: 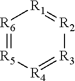
or the salts or tautomers thereof, wherein in the formula of the aromatic compound:
R1-R6 are each independently selected from CR_{c} and N; and
wherein R_{c} is independently selected from: H, F, Cl, Br, OH, NH2, NO2, CN, CHO, C₁-C₂₀-alkyl, C₁-C₂₀-hydroxyalkyl, C₁-C₂₀-alkyl ether, C₁-C₂₀-aminoalkyl, C₁C₂₀-alkyl carboxylic acid, C₁-C₂₀-aminoalkyl carboxylic acid, C₁-C₂₀-alkyl carboxamide, C₁-C₂₀-alkenyl which contains 1, 2, 3, 4, or 5 double bonds, alkyls partially substituted with carbocycles or heterocycles, alkyls fully substituted with carbocycles or heterocycles, and an option wherein R1 and R2 are taken together, with intervening atoms, to form a carbocycle, a heterocycle, a substituted carbocycle, or a substituted heterocycle.

11. The composition of claim 10, wherein the hydroxycarboxylic acid is selected from a group consisting of tartaric acid, galactaric acid, glucaric acid, malic acid, and hydroxycitric acid.

12. The composition of claim 10, further comprising 0.1% to 50% of a borate compound.

13. The composition of claim 10, wherein the organic compound is glucaric acid and comprises 20-85% of the composition; and
the aromatic compound is benzoic acid and comprises 15-80% of the composition.

14. The composition of claim 10, wherein the composition is dissolved in solution to 10-5000 ppm.

15. The composition of claim 10, further comprising at least one additive from a group consisting of antimicrobial compounds, antiscalants, surfactants/detergents, primers/sealants, acids/bases, oxygen scavengers, indicator dyes, additional buffer components, and/or metal salts.

16. A composition for corrosion inhibition in Galvanized Steel comprising:
20-80% of at least one hydroxydicarboxylic acid with two or three carboxylic functional groups and at least one hydroxyl functional group or salt thereof;
and
20-80% of a borate compound.

17. The composition of claim 16, wherein the composition is dissolved in solution to 10-5000 ppm.

18. The composition of claim 16, wherein the hydroxydicarboxylic acid is selected from a group consisting of tartaric acid, galactaric acid, glucaric acid, and malic acid.

19. The composition of claim 16, wherein the borate compound is selected from a group consisting of anhydrous borax, sodium tetraborate decahydrate, sodium borate decahydrate, sodium borate pentahydrate, potassium borate, potassium tetraborate and its hydrates, potassium pentaborate, zinc borate, boric acid, boric oxide, or sodium metaborate.

20. The composition of claim 16, further comprising 0.1-10% metal treatment additive.

21. The composition of claim 20, wherein the metal treatment additive is selected from the group consisting of Zinc, tin (II), magnesium, and nickel.

22. The composition of claim 16, wherein the hydroxydicarboxylic acid or salt thereof is galactaric acid or a salt thereof and comprises 40-60% of the composition; and wherein the borate compound comprising 40-60% of the composition; and the wherein the composition is dissolved in solution to 50-5000 ppm.

23. The composition of claim 16, further comprising at least one additive including one additive from a group consisting of antimicrobial compounds, antiscalants, surfactants/detergents, primers/sealants, acids/bases, oxygen scavengers, indicator dyes, additional buffer components.

24. A method for corrosion inhibition comprising:
forming a corrosion inhibition composition, the corrosion inhibition composition comprising: 20-85% of an organic compound with two or three carboxylic functional groups and at least one hydroxyl functional group, and 15-80% of an aromatic compound; and
applying the corrosion inhibition composition within a fluid system.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)
